(19) United States
(12) Patent Application Publication
(10) Pub. No.: US 2007/0133751 A1
(43) Pub. Date: Jun. 14, 2007

(54) Portable x-ray system

(76) Inventors: Peter Chicchetti, Coral Springs, FL (US); Michael Markert, Boca Raton, FL (US); Timothy Martinson, Boca Raton, FL (US); Chris Duca, Cape Coral, FL (US)

Correspondence Address: MALLOY & MALLOY, P.A., 2800 S.W. Third Avenue, Historic Coral Way, Miami, FL, 33129, US

(21) Appl. No.: 11/603,966

(22) Filed: Nov. 22, 2006

Related U.S. Application Data
(60) Provisional application No. 60/739,975, filed on Nov. 23, 2005.

(51) Int. Cl. H05G 1/02

(52) U.S. Cl. 378/193

(57) ABSTRACT

A portable X-Ray system that includes a first module with an x-ray processor, an input, a monitor, a power supply, an exterior interface, and a sensor panel, the sensor panel being operatively connected in data transfer communication with the x-ray processor by a first connector. The first connector permits the sensor panel to be disposed in spaced apart adjustable position relative to the x-ray processor and a subject to be x-rayed. The first module can be adjusted into a portable stored configuration and an operative configuration, and further includes a shock absorbent element structured to protect the sensor panel, the x-ray processor and the monitor from impacts when in the stored configuration. The system further includes a second module having an x-ray generator that can be disposed between a stored configuration and an operative configuration. A shock absorbent element is provided in the second module to protect the x-ray generator from impacts when the second module is in the stored configuration. A second connector is provided to communicatively connect the x-ray generator to the x-ray processor when the first and second modules are deployed in their operative configurations, a positioner also being included to position a portion of the x-ray generator in a spaced apart operative association with the sensor panel.

### CLAIM OF PRIORITY

The present application is based on and a claim to priority is made under 35 U.S.C. Section 119(e) to provisional patent application currently pending in the U.S. Patent and Trademark Office having Ser. No. 60/739,975 and a filing date of Nov. 23, 2005.

### BACKGROUND OF THE INVENTION

### Field of the Invention

The present invention relates to a portable x-ray system structured to be utilized primarily in a remote or non-dedicated environment, such as a tactical and/or military and/or emergency environment wherein an x-ray of a subject must be taken in an expedited and often confined and/or restricted environment, or at a location where a more permanent x-ray facility cannot be established. The portable x-ray system provides for substantial transport and portability while being easily and effectively deployed to quickly provide an x-ray image of a subject in a very controllable manner which provides very rapid access to the x-ray images for determination if the necessary x-ray image has been taken and/or immediate diagnosis.

### DESCRIPTION OF THE RELATED ART

X-ray technology has made a number of advances throughout the years, however the complexity and static nature of the associated equipment has seen few advances. For example, even though some smaller and/or more compact x-rays technologies have been developed, such as through the utilization of computer generated x-ray images versus traditional film type images, location specific, generally permanently mounted x-ray generators as well as dedicated x-ray exposure panels are typically the norm, thus requiring a patient to be brought to a specific x-ray facility and positioned within a substantially limited and confined area which is the area of operation of the x-ray device.

As can be appreciated, such rigidity of use can be substantially limiting and detrimental in an emergency and/or tactical environment where it is difficult and/or impossible to effectively move or transport a patient to a dedicated x-ray facility, and/or when a mobile or more confined x-ray taking environment must be employed because a dedicated and/or more permanent x-ray facility cannot be established. This is especially the case in a tactical and/or military environment whereby field medical personnel may encounter a subject and it would be beneficial to make a quick and accurate determination of broken bones, the location of projectiles, etc. without the need to transport the subject to a dedicated x-ray facility, which in many circumstances may not even be available. Moreover, in addition to the significant benefit of being able to make an immediate assessment without having to set up a permanent x-ray facility and/or transport a subject to the x-ray facility, making such a rapid and on the spot determination can be substantially helpful as it will allow a medical practitioner in many cases to make a rapid and/or immediate diagnosis, and follow an appropriate course of treatment on the spot. This can be particularly helpful if it can be determined that a particular injury or problem is immediately treatable and/or immediately stabilized in a manner which will allow the subject to be more safely transported and/or to return to operation until a more substantial treatment regimen can be addressed in a safe manner.

Accordingly, there is substantial need in the art for an x-ray system which is compact and portable, which can be quickly and effectively adjusted, even in a confined environment, which provides necessary protection and transportability to the x-ray equipment, and which provides a virtually immediate x-ray image for either diagnostic purposes or for immediate determination that the necessary x-ray image has been taken.

### SUMMARY OF THE INVENTION

The present invention relates to a portable x-ray system that preferably includes a number of modules. In particular, the portable x-ray system includes a first module that includes an x-ray processor, an input, a monitor, a power supply, an exterior interface and a sensor panel. Specifically, the first module is structured to be disposable in a stored configuration or an operative configuration, the stored configuration making the first module substantially portable so that it can be taken to a desired location for deployment. Along these lines, the first module may include a housing with at least one wheel, and possibly a handle to provide for facilitated transport of the first module and all of its components.

When in the operative configuration, the sensor panel is structured to be positioned in operative proximity to the subject in order to communicate x-ray image data to the x-ray processor. The x-ray processor in turn can display the information on the monitor and/or can store or transfer the x-ray data. In order to communicate that x-ray image data, the sensor panel of the first module is operatively connected in data transfer communication with the x-ray processor by a first connector which is structured to permit generally remote adjustable positioning of the sensor panel. As a result, the sensor panel can be effectively and appropriately positioned relative to a subject to be x-rayed, even in a cramped and/or confined environment.

In order to preserve and protect the sophisticated and delicate components of the first module, the first module also preferably includes a shock absorbent element. In particular, the shock absorbent element, which can include one or more pieces, protects at least the sensor pad, the x-ray processor and the monitor from impact when the first module is disposed in the stored configuration. As a result, the first module can be quickly and effectively transported to and from a desired location where an x-ray is to be achieved, and can be quickly and conveniently deployed to its operative configuration whereby the sensor panel can be adjustably and connectably disposed relative to the subject to be x-rayed, without a substantial risk that the components will be damaged during transit.

Looking to the second module, much like the first module, it also preferably includes an operative configuration and a stored configuration. When in the stored configuration the second module is structured to be effectively transported along with the first module, and when in the operative configuration it cooperates with the first module to generate x-ray images. As such, the second module includes an x-ray generator. In particular, the x-ray generator is preferably disposed in a housing of the second module during transport, and is structured to be shielded and protected from impacts by a shock absorbent element of the second module is disposed in its stored configuration. When use of the portable x-ray system is to be achieved, however, the x-ray generator is structured to be communicatably connected to the x-ray processor of the first module by a second connector. Thereafter, the x-ray generator can be positioned relative to the subject and in spaced apart distance from the sensor panel so as to emit x-rays to be detected by the sensor panel for appropriate generation of an x-ray image. Although positioning of the x-ray generator on any surface or support can be achieved, in the preferred embodiment a positioner is provided and is structured to suspend at least a portion of the x-ray generator, such as the x-ray head thereof, in a spaced apart operative association relative to the sensor panel.

These and other features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective illustration of the first module in its operative configuration;

FIG. 2 is a perspective illustration of the first module with a top portion of the housing open but with it substantially in its stored configuration;

FIG. 3 is a perspective illustration of a first embodiment of the first module in its stored configuration;

FIG. 4 is a perspective illustration of the x-ray generator of the second module operatively disposed; and

FIG. 5 is an illustration of the second module in a stored configuration.

Like reference numerals refer to like parts throughout the several views of the drawings.

### DETAILED DESCRIPTION OF THE PREFERRED EMBODIMENT

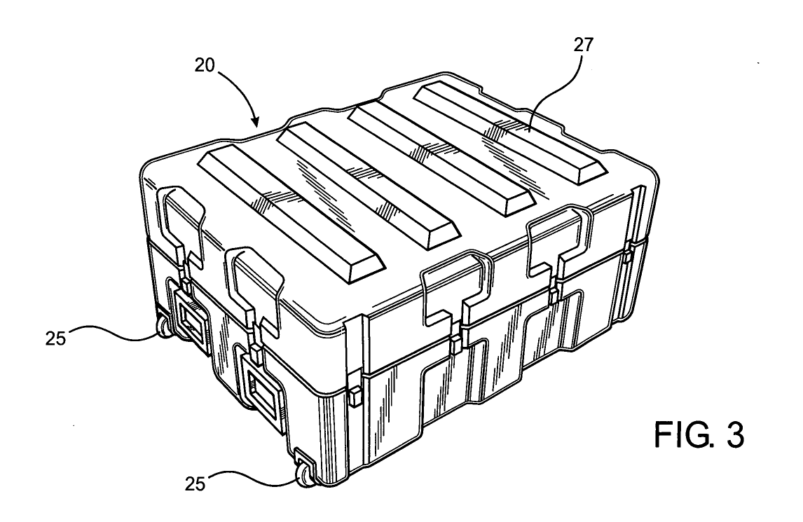

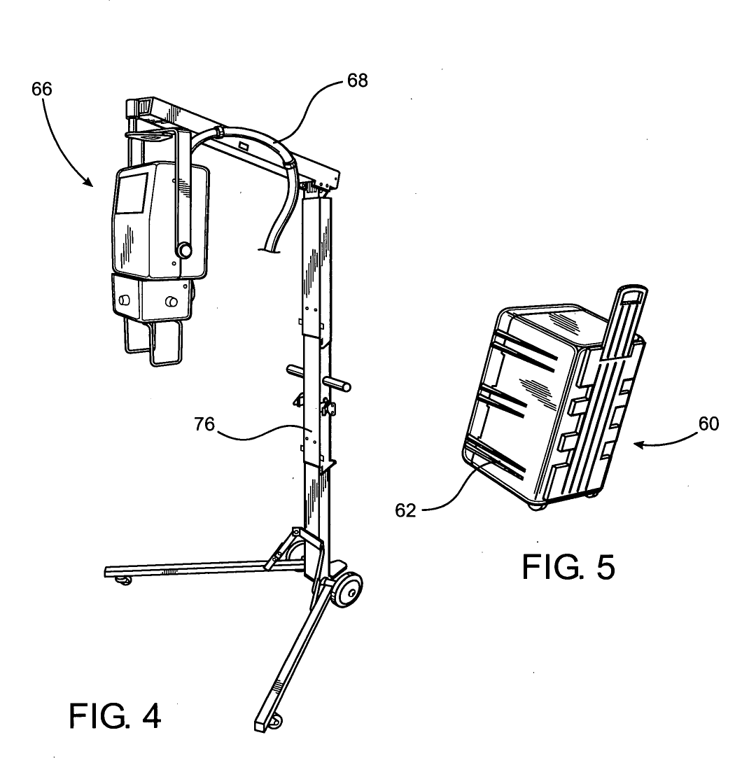

The present invention is directed towards a portable x-ray system. In particular, the portable x-ray system is configured for use in a portable and typically a tactical environment, such as in emergency situations and/or a military operation whereby remote use of x-ray equipment for taking images of a subject is required without having a dedicated x-ray facility and/or without having to transport a subject to a dedicated x-ray facility. Looking to the first embodiment of the portable x-ray system of the present invention, it includes a first module, generally 15. In the current illustrated embodiment of the first module 15, it may include a housing 20. In particular, the housing 20 will preferably be substantially impact resistant and provide for substantial portability of the remaining components of the first module 15. Furthermore, because of the tactical and/or remote environments wherein the portable x-ray system of the present invention may be taken, it is preferred that the housing 20 of the first module 15 be substantially watertight, and as illustrated in FIG. 3 may include a pressure release valve 27 so as to allow for effective transport and operation within an aircraft, including an unpressurized area of an aircraft. Additionally, so as to effectively achieve transport and portability of the housing 20, one or more wheels 25 are preferably included therewith so as to allow an individual to grasp a handle or other portion of the housing 20 and effectively pull or transport a first module 15 and all of its components as needed. Also, as an additional feature, not illustrated for purposes of clarity, a watertight power connector may also be provided within the housing to define a power supply, and be configured to be removed from an exterior wall of the housing 20 and then to be effectively plugged in to power the system, as needed, without provided an orifice wherein fluid can enter the housing and possibly damage other components of the first module 15, both during transport or use. Of course, it is understood that in some circumstances battery power may also be provided and/or incorporated within the housing 20 of the first module 15.

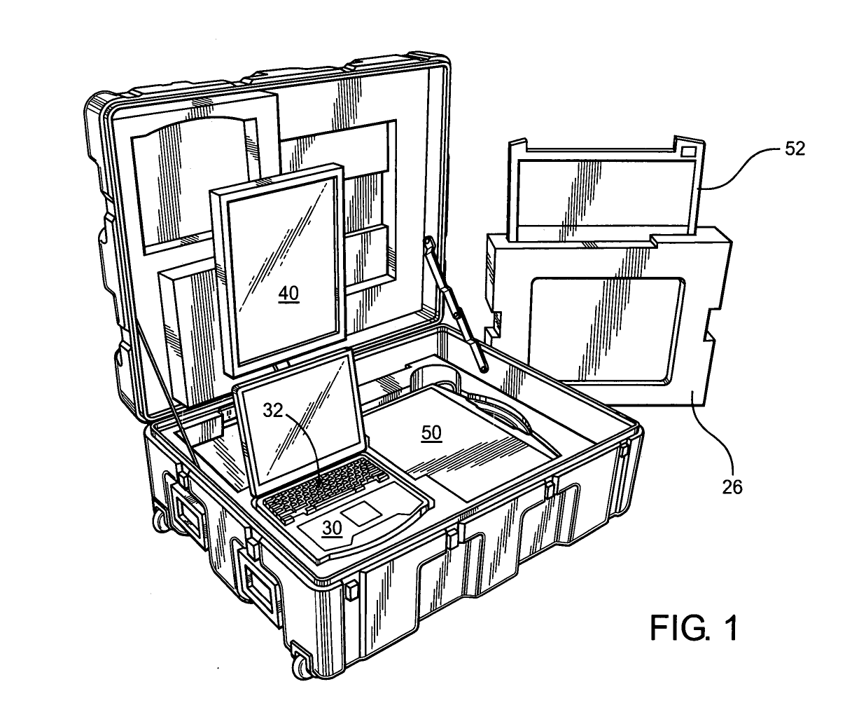

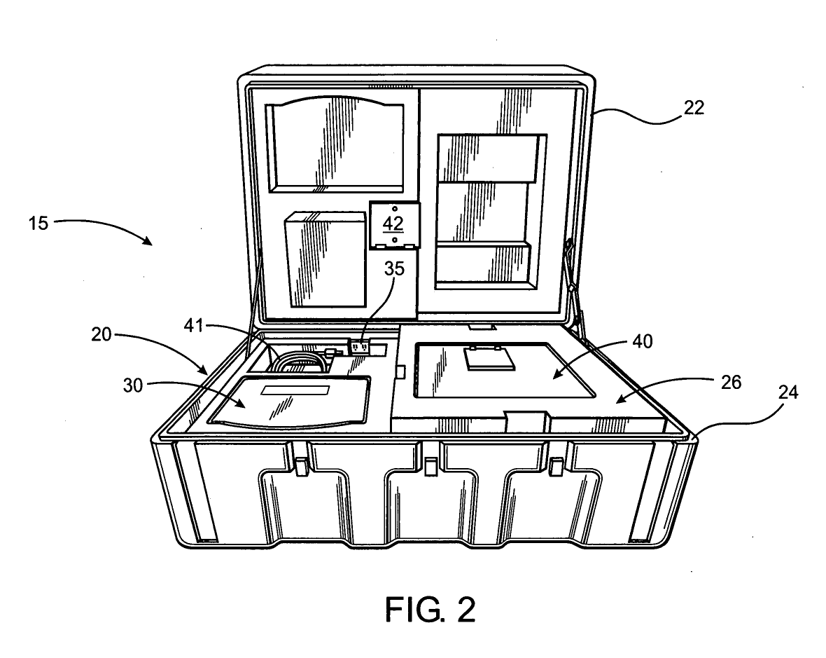

Turning again to FIGS. 1 and 2, the housing 20 preferably includes a base portion 24 and a cover portion 22, the cover portion 22 hingedly opening to reveal an interior of the housing 20 and the remaining components of the first module 15. Disposed within the housing is preferably a shock absorbent element 26. This shock absorbent element 26 can include one or more pieces, and in the illustrated embodiment includes shock absorbent foam padding. To shrowd and protect interior components.

The first module 15 also preferably includes an x-ray. processor 30. Specifically, the x-ray processor 30 is structured to receive, process, transmit and/or display x-ray images taken by the portable x-ray system of the present invention, and is also further structured to provide for automated control of an x-ray generator 66, as will be described subsequently. As can be shown in the figures, the x-ray processor 30 may include a portable computer that is effectively maintained within the housing 20. Also, as can be seen from the figures, the shock absorbent element 26 in the form of a quantity of foam padding, in either one or a plurality of pieces, can be formed to define compartments for each of the components, such as the x-ray processor. Nevertheless, during use, when the cover 22 of the housing 20 is open, the x-ray processor 30 will be effectively disposed in a usable and operative configuration, while still being maintained generally within the housing 20.

In addition to the x-ray processor 30, the present invention further includes an input 32. Although some sort of exterior input connected to the x-ray processor 30 may be effectively employed, in the illustrative embodiments the input 32 may include the keypad mouse and/or preferably a touch screen associated with the x-ray processor. In order to provide for substantially effective and useful display of x-ray images as well as control features, the first module 15 also preferably includes a monitor 40. In particular, the monitor 40 is preferably substantially high resolution so as to provide a clear and effective display of x-ray images. Additionally, if desired the monitor 40 can also serve as the input 32, the monitor 40 providing a touch screen display which is operatively connected with the x-ray processor 30, thereby allowing a practitioner facilitated control over the entire x-ray procedure, as well as facilitated views and the manipulation of x-ray images taken thereby. As illustrated in the figures, the monitor 40 is preferably contained within the housing 20 and is well protected by the shock absorbent element 26 during transport. In order to provide for effective use, however, a bracket 42 is provided in the housing 20, the monitor 40 being structured to be mounted on the bracket 42. Accordingly, as seen in FIG. 1, the monitor 40 is appropriately positioned in a viewable, still somewhat sheltered position in the housing 20, but is substantially usable by a practitioner who can view images thereon and/or utilize the monitor 40 as an input as needed.

The first module 15 also includes a sensor panel 50. In particular, the sensor panel 50 is a sophisticated piece of technology which is operatively positioned relative to the subject to be x-rayed and detects and/or captures x-rays images in order to generate an appropriate x-ray image. When the first module is in its stored configuration, as shown partially in FIG. 2 and more effectively in FIG. 3, the sensor panel 50 is effectively secured and shielded within the housing 20 by the shock absorbent element 26. When, however, the first module is positioned in its operative configuration, at least part of the shock absorbent element 26 is removed from the housing so as to allow the sensor panel 50 to be effectively removed from the housing 20 and placed in a proximity to the subject. Although a specific bracket or mounting structure can be provided for the sensor panel 50 as when such a sensor panel is traditionally used, in most circumstances, the sensor panel 50 of the portable x-ray system will merely be placed on an appropriate surface relative to the subject to be x-rayed, such as on a bed beneath the subject.

As an added component, and so as to provide some flexibility of use, if necessary, the first module 15 may also include a grid panel 52. In particular, the grid panel 52 is an accessory item that can be used in association with the sensor panel 50 so as to vary or block x-ray transmission into the sensor panel and provide variable image types as needed by a practitioner. In the illustrated embodiment of the first module 15, the grid panel 52 may be contained within a portion of the shock absorbent element 26 for effective protection when not in use, even if removed from the housing, and so as to be removed for use as needed by the practitioner.

The first module 15 also includes an exterior interface 35. Although multiple different exterior interfaces 35 may be employed, including some contained wholly within the housing 20 and some with exterior connectability through a wall of the housing 20, in the illustrated embodiment, the exterior interface at least partially includes a plurality of different ports and/or connectors 35 whereby all of the different components of the portable x-ray system of the present invention, and/or external components can be effectively interfaced for communication with one another, and possibly whereby they can communicate with a power supply such as a contained battery or an exterior power source as connected to with a retractable plug structure. In this regard, the monitor 40 must generally be connected to the x-ray processor 30, either directly and/or via the exterior interface 35 so that appropriate data transmitting and receiving communication therebetween can be achieved. Also, a first connector is preferably provided so as to effectively provide for communicative connection between the x-ray processor and the sensor panel 50, thereby allowing the sensor panel 50 be disposed in a spaced apart position from the x-ray processor 30, and in effective operative proximity to the subject to be x-rayed. Although this invention contemplates that some sort of wireless connectivity structure is provided so as to define the first connector, in the illustrated embodiment the first connector includes cabling 41. In particular, the cabling 41 is preferably generally elongate and provides for the appropriate communicative connection between the sensor panel 50 and the x-ray processor 30. In this regard, it is noted that the sensor panel may be connected directly to the x-ray processor whereby the exterior interface is part of the x-ray processor 30, or can be connected via a separate exterior interface, such as the interface 35 of the illustrated embodiments.

Accordingly, it is seen from the preceding description that when an x-ray of the subject is to be taken utilizing the portable x-ray system of the present invention, the first module 15 can effectively be deployed by positioning and opening the housing 20, locating the monitor 40 on its bracket 42, and by effective positioning of the sensor panel 50 in an operative proximity relative to the subject to be x-rayed. Once the x-ray has been taken, the x-ray data can be either utilized immediately directly on the monitor 40 and/or can be stored for subsequent use on the x-ray processor 30 and/or any exterior storage device, such an external hard drive, an additional processor or some sort of storage media. In the case of an external processor, it can be connected to the x-ray processor 30 either via an exterior interface 35 disposed within the housing 20 or an exterior interface which is part of the x-ray processor 30. Furthermore, the x-ray processor 30 can be effectively connected via wires or wirelessly to such an exterior processor for data transmitting communication, such as for transmission to a remote location over a computerized network for either storage and/or analysis by practitioners disposed remote from the actual site that the x-ray is being taken.

In order to actually complete the x-ray process, the x-ray system of the present invention also includes a second module, generally indicated as 60. In particular, a second module 60 also preferably includes a housing 62 and a shock absorbent element 64 that includes one or more elements, such as a plurality of padded panels as in the first module 15. Additionally included as part of the second module is an x-ray generator 66. In particular, the x-ray generator 66 is structured to be substantially compact and portable and is structured to emit x-rays toward a subject to be x-rayed, those X-rays to be detected and/or captured by the sensor panel 50 for appropriate generation of the x-ray image. Although a variety of different configurations of the x-ray generator 66 can be provided, preferably a substantially compact configuration is achieved whereby an x-ray head is positioned to emit the x-rays toward the subject. When not in use, the x-ray generator 66 is disposed within the housing 62 which can be closed effectively defining a stored configuration of the second module 60. When, however, the second module is to be disposed in operative configuration, the x-ray generator can be removed and appropriately positioned relative to the subject. Although the x-ray generator 66 can be positioned on any surface or mounted on any location, such as if it includes mounting brackets or hooks as part thereof, in a preferred embodiment a separate positioner 76 may be provided. Specifically, although the mounting brackets or hooks on the x-ray generator 66 may be considered a positioner, it may be preferred that a separate positioner 76 in the form of a stand be provided. Preferably the stand 76 is collapsible and thereby portable within its own housing and/or within the second module or first module housings. During use, the stand 76 is operatively disposed relative to the subject to be x-rayed and the x-ray generator is suspended therefrom so that it can appropriately be angled and/or oriented relative to the subject to provide for effective direction of the x-rays toward the subject.

Additionally, a second connector 68 is also preferably provided so as to effectively connect the x-ray generator 66 with the x-ray processor 30. As with the other components, even though the second connector 68 may include a structure for a wireless connectivity, it may be preferred that an elongate cable 68 be provided to connect the x-ray generator 66 to the x-ray processor 30. Of course, even though it is preferred that the x-ray generator 66 be connected to the x-ray processor 30, and/or the power supply of the first module, it is also understood that a completely self contained x-ray generator having its own power supply and/or its own connection to a power supply may be provided, and controls directly on the x-ray generator 66 may be provided for resulting in the emission of the x-rays. In such an embodiment no connection with the x-ray processor 30 is necessitated. Nevertheless, in the preferred, illustrated embodiment such connectivity is provided as the x-ray processor 30 will preferably be structured to control the operation of the x-ray generator 66, including signaling when to emit x-rays as well as controlling the power/intensity of the x-ray emission and/or other parameters that may be adjustable for a variety of different x-ray taking techniques.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A portable X-Ray system comprising:
a) a first module, said first module including an x-ray processor, an input, a monitor, a power supply, an exterior interface, and a sensor panel;
b) said sensor panel being operatively connected in data transfer communication with said x-ray processor by a first connector;
c) said first connector structured to permit said sensor panel to be disposed in spaced apart adjustable position relative to said x-ray processor and a subject to be x-rayed;
d) said first module further including a stored configuration and an operative configuration, said first module being substantially portable when disposed in said stored configuration;
e) said first module further including a shock absorbent element structured to protect at least said sensor panel, said x-ray processor and said monitor from impacts when said first module is in said stored configuration;
f) a second module, said second module including an x-ray generator and structured to be disposed between a stored configuration and an operative configuration;
g) said second module including a shock absorbent element structured to protect said x-ray generator from impacts when said second module is in said stored configuration;
h) a second connector structured to communicatively connect said x-ray generator to said x-ray processor when said first and said second modules are in said operative configurations; and
i) a positioner structured to position at least a portion of said x-ray generator in a spaced apart operative association with said sensor panel.

2. A portable x-ray system as recited in claim 1 wherein said first module further comprises a housing, said housing structured to contain said shock absorbent element and said x-ray processor, said input, said monitor, said power supply, said exterior interface, and said sensor panel.

3. A portable x-ray system as recited in claim 2 wherein said sensor panel is structured to be removed from said housing during use.

4. A portable x-ray system as recited in claim 2 wherein said housing is structured to at least partially contain said x-ray processor, said input and said monitor during use.

5. A portable x-ray system as recited in claim 4 wherein said housing includes a mounting bracket structured to receive said monitor in an at least partially upright orientation when said first module is in said operative orientation.

6. A portable x-ray system as recited in claim 2 wherein said housing of said first module comprises at least one wheel structured to facilitate movement thereof.

7. A portable x-ray system as recited in claim 1 wherein said input comprises a touch screen.

8. A portable x-ray system as recited in claim 7 wherein said x-ray processor includes said touch screen.

9. A portable x-ray system as recited in claim 1 wherein said second module further comprises a housing said housing structured to contain said shock absorbent element and said x-ray generator.

10. A portable x-ray system as recited in claim 9 wherein said housing of said second module comprises at least one wheel structured to facilitate movement thereof.

11. A portable x-ray system as recited in claim 1 wherein said x-ray generator comprises an x-ray head from which said x-rays are emitted.

12. A portable x-ray system as recited in claim 1 wherein said positioner comprises an adjustable stand structured to be secured to and support said x-ray head in an operative position relative to the subject to be x-rayed.

13. A portable x-ray system as recited in claim 1 wherein said first connector comprises an elongate cable structured to extend from said x-ray processor so as to permit connected positioning of said sensor panel relative to the subject to be x-rayed.

14. A portable x-ray system as recited in claim 1 wherein said sensor panel is responsive to x-rays emitted by said x-ray generator and is structured to communicate an x-ray image to said x-ray processor, said x-ray processor structured to display said x-ray image on said monitor for review by a practitioner.

15. A portable x-ray system as recited in claim 14 wherein said sensor panel is structured to communicate said x-ray image to said x-ray processor in under 5 minutes.

16. A portable x-ray system as recited in claim 14 wherein said sensor panel is structured to communicate said x-ray image to said x-ray processor in under 1 minute.

17. A portable x-ray system as recited in claim 14 wherein said sensor panel is structured to communicate said x-ray image to said x-ray processor in under 10 seconds.

18. A portable x-ray system as recited in claim 1 wherein said x-ray processor is structured to control said x-ray generator when operatively connected thereto.

19. A portable x-ray system as recited in claim 18 wherein said x-ray processor is structured to set a power of said x-ray generator in response to an input by a practitioner utilizing said input.

20. A portable x-ray system as recited in claim 1 wherein said second connector is coupled to said exterior interface.

21. A portable x-ray system as recited in claim 20 wherein said exterior interface is structured to be operatively connected with an exterior processor and to communicate x-ray images thereto from said x-ray processor.
